(19) United States
(12) Patent Application Publication
(10) Pub. No.: US 2026/0080213 A1
(43) Pub. Date: Mar. 19, 2026

(54) STATE ESTIMATION DEVICE

(71) Applicant: Mitsubishi Electric Corporation, Tokyo (JP)

(72) Inventors: Takeru SHIRAGA, Tokyo (JP); Yoshie IMAI, Tokyo (JP)

(73) Assignee: Mitsubishi Electric Corporation, Tokyo (JP)

(21) Appl. No.: 19/396,672

(22) Filed: Nov. 21, 2025

Related U.S. Application Data
(63) Continuation of application No. PCT/JP2023/020042, filed on May 30, 2023.

(51) Int. Cl. G06N 3/045; G06N 3/08

(52) U.S. Cl. CPC G06N 3/045; G06N 3/08

(57) ABSTRACT

A state estimation device includes an addition unit configured to add personalized optimization information to a parent model for estimating a state of a person by inputting detection data detected from the person, the personalized optimization information being used for making estimation, which is performed using the parent model, suitable for a user; and a state estimation unit configured to estimate a state of the user by inputting detection data detected from the user, into the parent model to which the personalized optimization information added.

### CROSS REFERENCE TO RELATED APPLICATION

This application is a continuation application of International Application No. PCT/JP2023/020042 having an international filing date of May 30, 2023.

### BACKGROUND OF THE INVENTION

### 1. Field of the Invention

The present disclosure relates to a state estimation device.

### 2. Description of the Related Art

Conventionally, there are technologies that aim to estimate a user's state by using detection data such as biological signals obtained from wearable devices or the like. In general, biological information differs among individuals, which makes it difficult to prepare a general-purpose model in advance that is applicable to all users.

Thus, for example, a situation estimation device described in Patent Reference 1 receives signals from a wearable device worn by a user, selects a model from pre-trained models based on the received signals, and retrains the selected model every time training data is acquired. Consequently, the situation estimation device described in Patent Reference 1 can improve the estimation accuracy of the user's situation, enabling each user to estimate their state by using a model optimized for the individual.

[PATENT REFERENCE 1]: Japanese Patent Application Publication No.2022-55736

However, in the conventional art, an inference model for each user is individually optimized by retraining a state estimation model through the use of data obtained from each user. For this reason, the model needs to be retrained for each user using the system, and the system must store a corresponding number of models based on the number of users.

In recent years, estimation models using neural networks and similar techniques have become increasingly complex, which leads to a corresponding increase in model size (i.e., capacity). As a result, when such models are employed in a system, retraining these models takes a significant amount of time.

Therefore, one or more aspects of the present disclosure aim to enable an appropriate estimation for each user without the need to retrain the state estimation model.

A state estimation device according to one aspect of the present disclosure includes: processing circuitry to add personalized optimization information to a parent model for estimating a state of a person by inputting detection data detected as a plurality of types of data from the person, the personalized optimization information being used for making estimation, which is performed using the parent model, suitable for a user; and to estimate a state of the user by inputting detection data detected from the user, into the parent model to which the personalized optimization information added.

According to one or more aspects of the present disclosure, an appropriate estimation can be performed for each user without retraining the state estimation model.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of a state estimation device according to a first embodiment,

FIG. 2 schematically illustrates a diagram for explaining an example of adding personalized optimization information to an output of a parent model,

FIGS. 3A and 3B are schematic diagrams for explaining an example of adding the personalized optimization information to part of the layers of the parent model,

FIG. 4 is a block diagram schematically illustrating a configuration of a PC,

FIG. 5 is a block diagram schematically illustrating a configuration of a state estimation device according to a second embodiment, and

FIG. 6 is a block diagram schematically illustrating a configuration of a state estimation device according to a third embodiment.

### DETAILED DESCRIPTION OF THE INVENTION

### First Embodiment

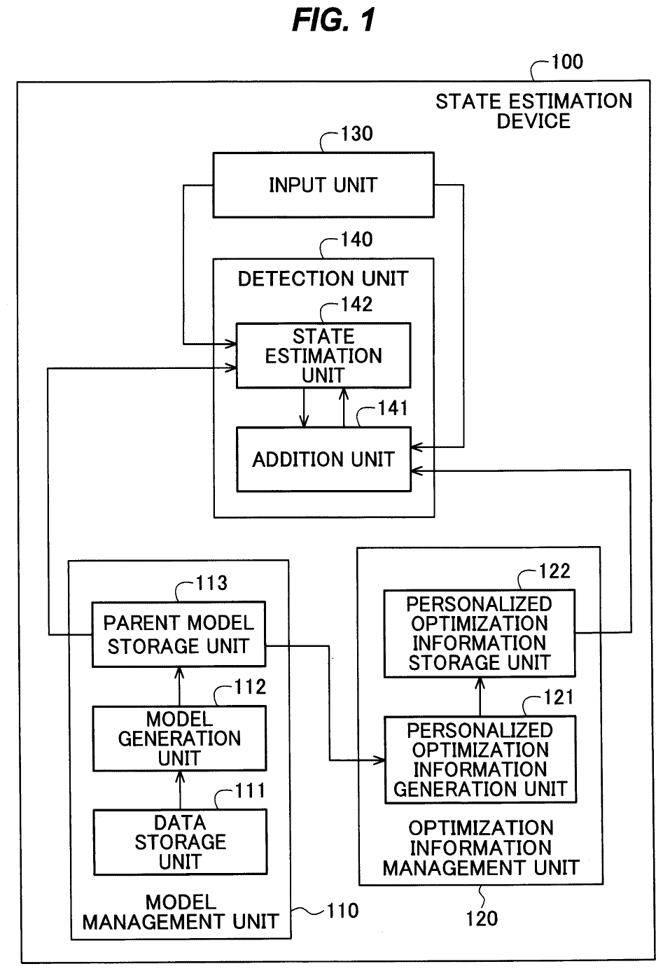

FIG. 1 is a block diagram schematically illustrating a configuration of a state estimation device 100 according to a first embodiment.

The state estimation device 100 includes a model management unit 110, an optimization information management unit 120, an input unit 130, and a detection unit 140.

The model management unit 110 includes a data storage unit 111, a model generation unit 112, and a parent model storage unit 113.

The data storage unit 111 stores teacher data for training a parent model to be described below.

The state estimation device 100 is a device that estimates a user's state based on detection data detected from the user. Thus, the teacher data here includes detection data detected from a person and the person's state estimated based on the detection data. In addition to the detection data, the teacher data may also include clinical data about a person, which has been collected at a hospital or the like, and the person's state or condition diagnosed from the clinical data.

The model generation unit 112 uses the teacher data stored in the data storage unit 111 to train a parent model, which is a model for estimating a person's state, based on the detection data detected from the person.

The parent model storage unit 113 is a storage unit that stores the parent model generated by the model generation unit 112.

In the above-mentioned example, the parent model is generated by the model generation unit 112, but the first embodiment is not limited to such an example. For example, the parent model may be generated by a device different from the state estimation device 100 and stored in the parent model storage unit 113. In this case, the data storage unit 111 and the model generation unit 112 may be omitted.

The optimization information management unit 120 includes a personalized optimization information generation unit 121 and a personalized optimization information storage unit 122.

The personalized optimization information generation unit 121 generates personalized optimization information for modifying part of the parent model or its output such that estimation using the parent model is suitable for the user using the state estimation device 100.

For example, the personalized optimization information generation unit 121 may use data (also referred to as “personalized optimization data”) that associates detection data previously obtained from the user of the state estimation device 100 with a user's state at the time the detection data is obtained, to generate personalized optimization information for the user so that the user's state can be estimated based on an output provided when the detection data is input into the parent model. Such personalized optimization data may be input via the input unit 130 or stored in the data storage unit 111.

The personalized optimization information storage unit 122 stores the personalized optimization information generated by the personalized optimization information generation unit 121. Here, in a case where a plurality of users use the state estimation device 100, the personalized optimization information is stored in association with each of the users. For example, each of the users may be assigned a user ID (IDentification) as user identification information, which is identification information for identifying the corresponding user, and the personalized optimization information may be associated with the user ID.

In the first embodiment, it is assumed that the personalized optimization information about the user has already been generated and stored in the personalized optimization information storage unit 122 before the user's state is estimated by the state estimation device 100.

In the above example, the personalized optimization information is generated by the personalized optimization information generation unit 121, but the first embodiment is not limited to such an example. For example, the personalized optimization information may be generated by a device different from the state estimation device 100 and stored in the personalized optimization information storage unit 122. In this case, the personalized optimization information generation unit 121 may be omitted.

The input unit 130 functions as an input receiving unit that receives inputs of various types of data.

For example, the input unit 130 receives an input of the user ID of the user of the state estimation device 100.

The input unit 130 also functions as a detection data receiving unit that receives an input of the detection data detected from the user of the state estimation device 100. Here, the detection data is desirably, for example, vital data detected by a sensor (not illustrated). The vital data may be detected by a medical device (not illustrated) or by a user terminal (not illustrated) such as a smartwatch used by the user.

The input user ID and detection data are provided to the detection unit 140.

The detection unit 140 includes an addition unit 141 and a state estimation unit 142.

The addition unit 141 reads personalized optimization information, which corresponds to the user ID provided from the input unit 130, from the personalized optimization information storage unit 122.

The addition unit 141 then adds the read personalized optimization information to a parent model stored in the parent model storage unit 113. The parent model to which the personalized optimization information is added makes the estimation suitable for the user. Specifically, when the parent model includes a plurality of sub-models that estimates a person's state from respective types of data included in the detection data, the addition unit 141 adds the personalized optimization information, which is information used to estimate the user's state, to an output of the parent model by weighting and evaluating outputs of the sub-models. The addition unit 141 may also add, to the parent model, information for modifying the output of part of the layers of the parent model to suit the user as the personalized optimization information.

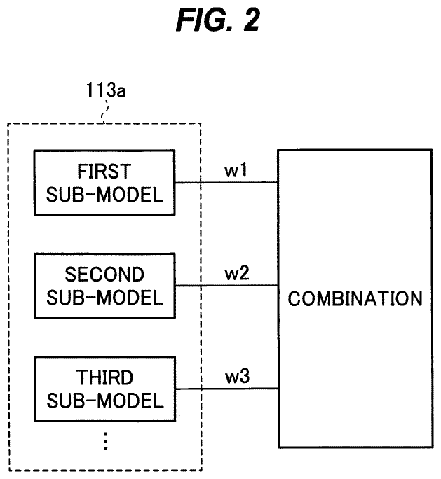

FIG. 2 schematically illustrates a diagram for explaining an example of adding personalized optimization information to an output of a parent model.

For example, as shown in FIG. 2, when a parent model 113a is composed of a plurality of sub-models including a first model, a second model, and so on, each sub-model is used to perform estimation for the respective types of data included in the detection data. In this case, the personalized optimization information can be generated by weighting the outputs from the multiple sub-models with weights (e.g., w1, w2, w3, . . . ) determined for each user and then combining the weighted outputs and be used as information for estimating the user's state based on the combined results.

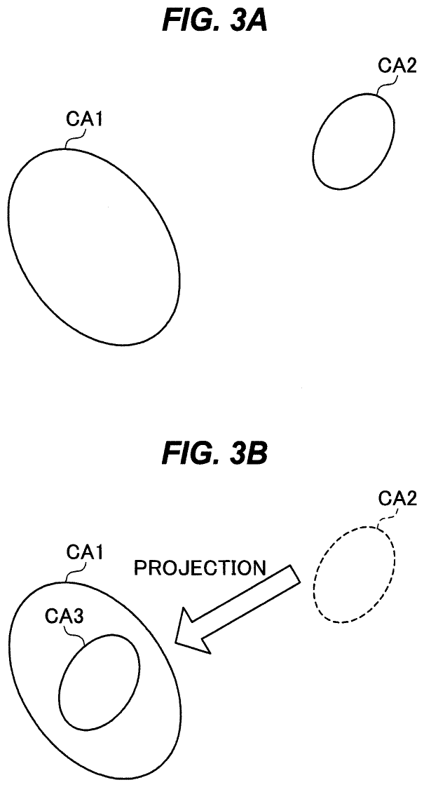

FIGS. 3A and 3B are schematic diagrams for explaining an example of adding the personalized optimization information to part of the layers of the parent model.

As illustrated in FIG. 3A, in a case where a normal space CA1 assumed by the parent model differs from a normal space CA2 that corresponds to data which is obtained when the user's state is normal out of the user's detection data, for example, biological information about the user in a normal state may not be mapped within the normal space assumed by the parent model and may be erroneously determined as abnormal.

Thus, the addition unit 141 inserts a projection function into part of the layers of the parent model to modify the outputs of those layers for each user. As a result, as illustrated in FIG. 3B, a normal space CA3, which corresponds to data which is obtained when the user's state is normal out of the user's detection data, matches the normal space CA1 assumed by the parent model. In such a case, the projection function inserted in part of the layers of the parent model serves as the personalized optimization information.

The state estimation unit 142 estimates the user's state by inputting detection data detected from the user into the parent model to which the personalized optimization information is added.

The estimated user's state is displayed, for example, on a display unit (not illustrated) or transmitted to a terminal used by the user via a communication unit (not illustrated). In other words, the estimated user's state is output from an output unit (not illustrated).

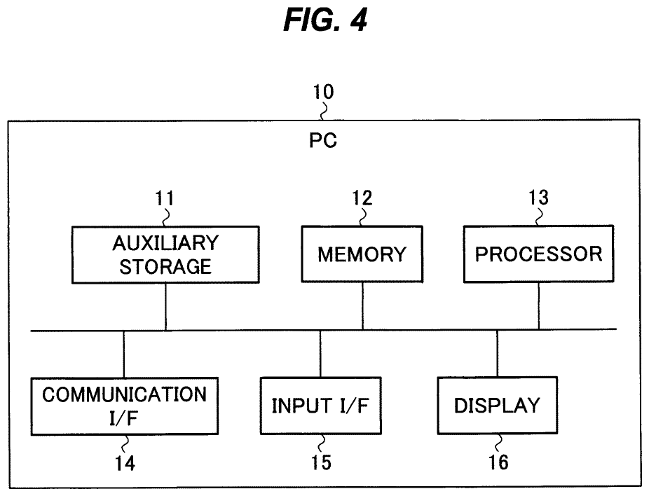

The state estimation device 100 described above can be implemented by a computer, such as a PC 10 illustrated in FIG. 4.

The PC 10 includes auxiliary storage 11, such as a Hard Disk Drive (HDD) or a Solid State Drive (SSD), a memory 12, a processor 13 such as a Central Processing Unit (CPU), a communication InterFace (I/F) 14 such as a Network Interface Card (NIC), an input I/F 15 such as a mouse or a keyboard, and a display 16.

The data storage unit 111, the parent model storage unit 113, and the personalized optimization information storage unit 122 of the state estimation device 100 can be implemented by the auxiliary storage 11 or the memory 12. In other words, the data storage unit 111, the parent model storage unit 113, and the personalized optimization information storage unit 122 can be implemented by storage.

The model generation unit 112, the personalized optimization information generation unit 121, the addition unit 141, and the state estimation unit 142 can be implemented by the processor 13 reading a program stored in the auxiliary storage 11 into the memory 12 and executing the program. In other words, the model generation unit 112, the personalized optimization information generation unit 121, the addition unit 141, and the state estimation unit 142 can be implemented by processing circuitry.

The input unit 130 can be implemented by the communication I/F 14 or the input I/F 15.

The output unit (not illustrated) can be implemented by the communication I/F 14 or the display 16.

As described above, according to the first embodiment, estimations suitable for each user can be performed using the parent model without the need to retrain the parent model itself for each user.

### Second Embodiment

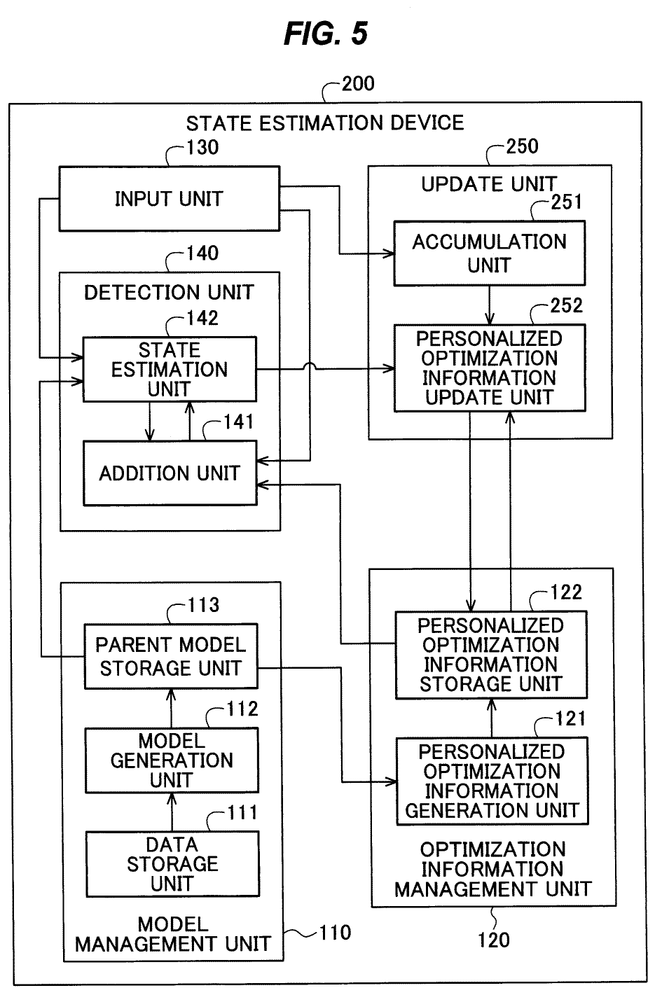

FIG. 5 is a block diagram schematically illustrating a configuration of a state estimation device 200 according to a second embodiment.

The state estimation device 200 includes the model management unit 110, the optimization information management unit 120, the input unit 130, the detection unit 140, and an update unit 250.

The model management unit 110, the optimization information management unit 120, the input unit 130, and the detection unit 140 of the state estimation device 200 according to the second embodiment are the same as the model management unit 110, the optimization information management unit 120, the input unit 130, and the detection unit 140 of the state estimation device 100 according to the first embodiment, respectively.

However, the input unit 130 provides the input user ID and the detection data to the update unit 250 as well.

The update unit 250 includes an accumulation unit 251 and a personalized optimization information update unit 252.

The accumulation unit 251 stores the user ID and the detection data from the input unit 130 in association with each other.

The personalized optimization information update unit 252 reads the personalized optimization information associated with the user ID that is stored in the accumulation unit 251, from the personalized optimization information storage unit 122, and then updates the personalized optimization information by using the detection data associated with the user ID.

Here, the personalized optimization information update unit 252 may update the personalized optimization information about the user when the user's state in the detection data is clarified. The user's state in the detection data can be clarified, for example, by being input into the input unit 130 by the user or a third party, such as a doctor.

In other words, when a user's state corresponding to the detection data detected from the user is acquired, the personalized optimization information update unit 252 updates the personalized optimization information such that the acquired state is estimated from the detection data.

Specifically, as illustrated in FIG. 2, when the personalized optimization information can be generated by weighting the outputs from the multiple sub-models with weights determined for each user and then combining the weighted outputs and be used as information for estimating the user's state based on the combined results, the personalized optimization information update unit 252 updates the weights such that the user's state, which is estimated based on an output obtained by inputting the detection data into the parent model, becomes the clarified user's state.

As described using FIGS. 3A and 3B, when the personalized optimization information is the projection function inserted into part of the layers of the parent model, the personalized optimization information update unit 252 updates the projection function such that the output obtained by inputting the detection data into the parent model indicates the clarified user's state.

The state estimation device 200 described above can also be implemented by a computer such as the PC 10 illustrated in FIG. 4.

For example, the accumulation unit 251 can be implemented by the auxiliary storage 11 or memory 12. In other words, the accumulation unit 251 can be implemented by storage.

In addition, the personalized optimization information update unit 252 can be implemented by the processor 13 reading a program stored in the auxiliary storage 11 into the memory 12 and executing the program. In other words, the personalized optimization information update unit 252 can be implemented by processing circuitry.

As described above, according to the second embodiment, the state estimation device 200 can be used to update the personalized optimization information such that it becomes further optimized. Thus, by using the state estimation device 200, the estimation accuracy for each user is further enhanced.

### Third Embodiment

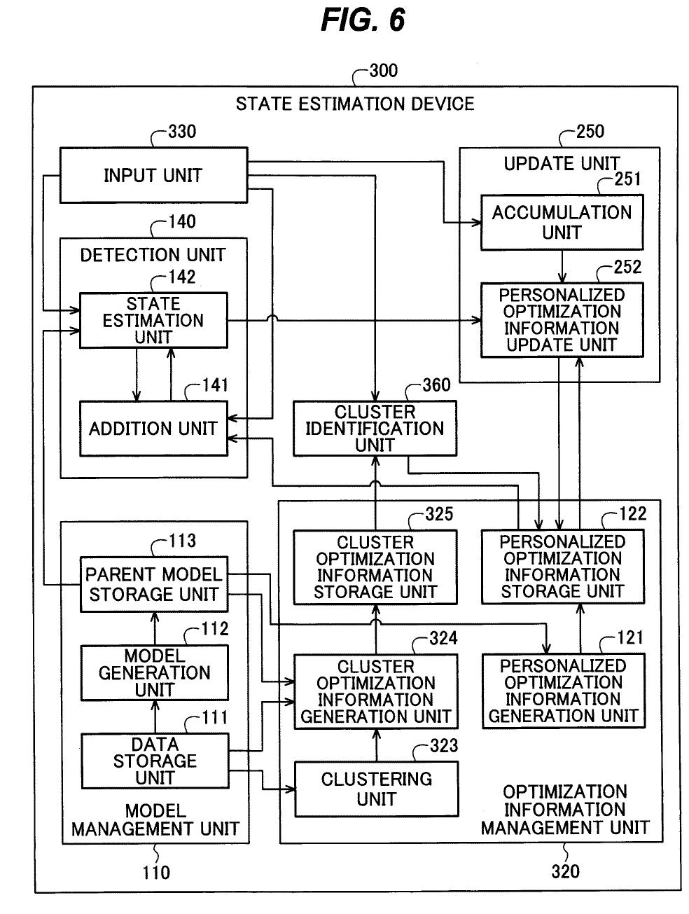

FIG. 6 is a block diagram schematically illustrating a configuration of a state estimation device 300 according to a third embodiment.

The state estimation device 300 includes the model management unit 110, an optimization information management unit 320, an input unit 330, the detection unit 140, the update unit 250, and a cluster identification unit 360.

The model management unit 110 and the detection unit 140 of the state estimation device 300 according to the third embodiment are the same as the model management unit 110 and the detection unit 140 of the state estimation device 100 according to the first embodiment, respectively.

The update unit 250 of the state estimation device 300 according to the third embodiment is the same as the update unit 250 of the state estimation device 200 according to the second embodiment.

The optimization information management unit 320 includes the personalized optimization information generation unit 121, the personalized optimization information storage unit 122, a clustering unit 323, a cluster optimization information generation unit 324, and a cluster optimization information storage unit 325.

The optimization information management unit 320 includes the personalized optimization information generation unit 121, the personalized optimization information storage unit 122, a clustering unit 323, a cluster optimization information generation unit 324, and a cluster optimization information storage unit 325.

The personalized optimization information generation unit 121 and the personalized optimization information storage unit 122 of the optimization information management unit 320 in the third embodiment are the same as the personalized optimization information generation unit 121 and the personalized optimization information storage unit 122 of the optimization information management unit 120 in the first embodiment, respectively.

The clustering unit 323 performs clustering by using teacher data stored in the data storage unit 111 to generate clusters, each of which is a group of similar users. As for the clustering performed here, known methods for grouping data (clusters) based on similarity between data may be used.

For example, when the teacher data includes user's clinical data, the clustering unit 323 can perform clustering by using attributes, such as a subject's age, medical history, and lifestyle, included in the clinical data.

The clustering unit 323 may also perform clustering by using the detection data included in the teacher data.

Further, the clustering unit 323 may perform clustering by using both the subject's attributes and the detection data. For example, the clustering unit 323 may cluster a feature space after incorporating the subject's attributes into the quantitative features calculated from the detection data.

The cluster optimization information generation unit 324 generates cluster optimization information to modify part of the parent model or its output such that the output from the parent model aligns with the cluster generated by the clustering unit 323.

For example, the cluster optimization information generation unit 324 may generate the cluster optimization information for each cluster such that the user's state can be estimated using the output obtained when the user's detection data, included in the clusters generated by the clustering unit 323, is input into the parent model.

The cluster optimization information storage unit 325 stores the cluster optimization information generated by the cluster optimization information generation unit 324. For example, each cluster is assigned a corresponding cluster ID as cluster identification information, which is identification information for identifying each cluster, and the cluster optimization information only needs to be associated with the cluster ID.

In the above example, the cluster optimization information is generated by the cluster optimization information generation unit 324, but the third embodiment is not limited to such an example. For example, the cluster optimization information may be generated by a device different from the state estimation device 300 and stored in the cluster optimization information storage unit 325. In such a case, the clustering unit 323 and the cluster optimization information generation unit 324 may be omitted.

The input unit 330 receives inputs of various data.

For example, as in the first embodiment, the input unit 330 receives an input of the user ID of the user of the state estimation device 300.

As in the first embodiment, the input unit 330 receives an input of the detection data detected from the user of the state estimation device 300.

The input user ID and the detection data are provided to the detection unit 140 and the update unit 250.

In the third embodiment, the input unit 330 also functions as a clustering data input receiving unit that receives an input of clustering data, which is data necessary for clustering the user of the state estimation device 300.

For example, when the cluster optimization information generation unit 324 uses the subject's attribute to generate a cluster through clustering, attribute data indicating the user's attribute serves as the clustering data.

Alternatively or additionally, when the cluster optimization information generation unit 324 uses the detection data to generate a cluster through clustering, the user's detection data serves as the clustering data.

Furthermore, when the cluster optimization information generation unit 324 uses the subject's attributes and detection data to generate a cluster through clustering, the attribute data indicating the user's attribute and the detection data serve as the clustering data.

The input unit 330 provides the user ID and the clustering data to the cluster identification unit 360.

The cluster identification unit 360 identifies the user's cluster, indicated by the user ID provided from the input unit 330, by executing clustering through the use of the clustering data from the input unit 330. The clustering here may be performed in the same way as the clustering performed in the clustering unit 323.

In other words, the cluster identification unit 360 identifies the cluster to which the user belongs, out of a plurality of clusters based on at least one of the user's attributes and the detection data detected from the user.

The cluster identification unit 360 then reads cluster optimization information associated with the cluster ID of the identified cluster from the cluster optimization information storage unit 325, and stores the cluster optimization information as the personalized optimization information in the personalized optimization information storage unit 122, while associating it with the user ID from the input unit 330. The cluster optimization information stored as the personalized optimization information is updated by the personalized optimization information update unit 252, as in the second embodiment.

The state estimation device 300 described above can also be implemented by a computer such as the PC 10 illustrated in FIG. 4.

For example, the cluster optimization information storage unit 325 can be implemented by the auxiliary storage 11 or memory 12. In other words, the cluster optimization information storage unit 325 can be implemented by storage.

The clustering unit 323, the cluster optimization information generation unit 324, and the cluster identification unit 360 can be implemented by the processor 13 reading a program stored in the auxiliary storage 11 into the memory 12 and executing the program. In other words, the clustering unit 323, the cluster optimization information generation unit 324, and the cluster identification unit 360 can be implemented by processing circuitry.

As described above, according to the third embodiment, even when the personalized optimization information about a user of the state estimation device 300 is not stored in the state estimation device 300, estimation can be performed by using cluster optimization information about a cluster in which a similar user is classified as an initial value. Then, as the user uses the state estimation device 300, the personalized optimization information is updated such that it becomes further optimized. Thus, by using the state estimation device 300, the estimation accuracy for each user is further enhanced.

In the first to third embodiments described above, an example of performing the processing in each of the state estimation devices 100 to 300 has been described, but the first to third embodiments are not limited to these examples. For example, the processing performed by each of the state estimation devices 100 to 300 according to the first to third embodiments may be distributed across a plurality of computers such as servers and PCs connected to a network such as the Internet. In other words, the processing performed by each of the state estimation devices 100 to 300 according to the first to third embodiments may be performed by the state estimation system.

For example, in the first embodiment, the state estimation system may be composed of a server (not illustrated) including the model management unit 110 and the optimization information management unit 120, and the PC (state estimation device) including the input unit 130 and the detection unit 140. In the second embodiment, the state estimation system may be composed of a server (not illustrated) including the model management unit 110 and the optimization information management unit 120, and the PC (state estimation device) including the input unit 130, the detection unit 140, and the update unit 250. Furthermore, in the third embodiment, the state estimation system may be composed of a server (not illustrated) including the model management unit 110 and the optimization information management unit 320, and the PC (state estimation device) including the input unit 330, the detection unit 140, the update unit 250, and the cluster identification unit 360.

What is claimed is:

1. A state estimation device, comprising: processing circuitry
to add personalized optimization information to a parent model for estimating a state of a person by inputting detection data detected as a plurality of types of data from the person, the personalized optimization information being used for making estimation, which is performed using the parent model, suitable for a user; and
to estimate a state of the user by inputting detection data detected from the user, into the parent model to which the personalized optimization information added,
wherein the parent model includes a plurality of sub-models are configured to estimate the state of the person from the respective types of data, and
wherein the personalized optimization information is information for estimating the state of the user by weighting and evaluating outputs of the sub-models.

2. The state estimation device according to claim 1, wherein the processing circuitry updates the personalized optimization information such that, when a state of the user corresponding to detection data detected from the user is acquired, the acquired state is estimated from the detection data corresponding to the acquired state.

3. The state estimation device according to claim 1, wherein the processing circuitry identifies a cluster to which the user belongs, out of a plurality of clusters, based on an attribute of the user and the detection data detected from the user, identifies cluster optimization information corresponding to the identified cluster from a plurality of items of cluster optimization information to be used for making estimation, which is performed using the parent model, suitable for persons classified into the respective clusters, adds the identified cluster optimization information to the parent model as the personalized optimization information, and updates the identified cluster optimization information such that, when a state of the user corresponding to detection data detected from the user is acquired, the acquired state is estimated from the detection data corresponding to the acquired state.

4. A state estimation device, comprising: processing circuitry
to add personalized optimization information to a parent model for estimating a state of a person by inputting detection data detected from the person, the personalized optimization information being used for making estimation, which is performed using the parent model, suitable for a user; and
to estimate a state of the user by inputting detection data detected from the user, into the parent model to which the personalized optimization information added,
wherein the personalized optimization information is information for modifying an output of a layer of part of the parent model to suit the user.

5. The state estimation device according to claim 4, wherein the processing circuitry updates the personalized optimization information such that, when a state of the user corresponding to detection data detected from the user is acquired, the acquired state is estimated from the detection data corresponding to the acquired state.

6. The state estimation device according to claim 4, wherein the processing circuitry identifies a cluster to which the user belongs, out of a plurality of clusters, based on an attribute of the user and the detection data detected from the user, identifies cluster optimization information corresponding to the identified cluster from a plurality of items of cluster optimization information to be used for making estimation, which is performed using the parent model, suitable for persons classified into the respective clusters, adds the identified cluster optimization information to the parent model as the personalized optimization information, and updates the identified cluster optimization information such that, when a state of the user corresponding to detection data detected from the user is acquired, the acquired state is estimated from the detection data corresponding to the acquired state.

7. A state estimation device, comprising: processing circuitry
to add personalized optimization information to a parent model for estimating a state of a person by inputting detection data detected from the person, the personalized optimization information being used for making estimation, which is performed using the parent model, suitable for a user;
to estimate a state of the user by inputting detection data detected from the user, into the parent model to which the personalized optimization information added; and
to identify a cluster to which the user belongs, out of a plurality of clusters, based on an attribute of the user and the detection data detected from the user,
wherein the processing circuitry identifies cluster optimization information corresponding to the identified cluster from a plurality of items of cluster optimization information to be used for making estimation, which is performed using the parent model, suitable for persons classified into the respective clusters, adds the identified cluster optimization information to the parent model as the personalized optimization information, and updates the identified cluster optimization information such that, when a state of the user corresponding to detection data detected from the user is acquired, the acquired state is estimated from the detection data corresponding to the acquired state.
